(19) United States
(12) Patent Application Publication
(10) Pub. No.: US 2024/0309902 A1
(43) Pub. Date: Sep. 19, 2024

(54) SPACING FASTENER

(71) Applicant: EJOT SE & Co. KG, Bad Berleburg (DE)

(72) Inventors: Uwe SIEGEMUND, Bad Berleburg (DE); Daniel WAGNER, Bad Laasphe (DE)

(21) Appl. No.: 18/577,223

(22) PCT Filed: Jul. 8, 2022
(86) PCT No.: PCT/EP2022/069111

§ 371 Date: Jan. 5, 2024

(30) Foreign Application Priority Data
Jul. 8, 2021 (DE) 102021117723.5

(51) Int. Cl. F16B 25/00; F16B 25/10

(52) U.S. Cl. CPC F16B 25/0063; F16B 25/0031; F16B 25/103

(57) ABSTRACT

A spacing fastener comprises a head and a shaft adjoining the head and ending with a tip. The shaft comprises an anchoring screw thread, an under-head screw thread closest to and ending near the head, and a non-threaded shaft portion therebetween. A support element at a distance circumferentially from the screw-thread end of under-head screw thread forms contact point (Au) therewith. In the region overlapping with under-head screw thread in top view, the support element is spaced apart therefrom and forms a contact point (As) for an outer shell lying between the head and under-head screw thread. The distance of contact point (As) from the head is greater than or equal to difference between the distance of contact point (Au) from the head and a tolerance distance of at most 15% of the major diameter of the under-head screw thread. The support element extends lengthwise over less than 150°.

The invention relates to a spacing fastener for fastening an outer shell of a building to a substructure.

Generic spacing fasteners are known in the art, for example from EP 3 415 773 A1, which are used for fastening outer shells to a substructure. In this case, the outer shell is held between the head and an under-head screw thread. A sealing element is arranged between the head and the outer shell, which sealing element generally takes the form of a sealing washer which is disposed between the head of the spacing fastener and the outer shell. Once the spacing fastener is in place, the through-hole in the outer shell, into which the spacing fastener has been inserted, is then sealed. The outer shells are regularly thicker than 0.35 mm, in particular between 0.4 mm and 1.0 mm. The outer shells can be cover sheets of a sandwich panel, a trapezoidal sheet, or the like. The space between the outer shell and the substructure can also be fitted with an insulating material.

The purpose of these spacing fasteners is to fix the outer shell in placer at a predetermined distance from the substructure with as little stress as possible.

Because the insulating material is flexible, this may result in damage to the sealing of the outer shell, for example, in the event of high wind pressure on the outer shell, or owing to settling or creeping processes in the insulating material, particularly in the case of a spacing fastener with a single-start under-head screw thread with increasing pitch of the under-head screw thread.

To overcome this problem, it was proposed in EP 3 415 773 A1 that the under-head screw thread be designed as a short, multi-start thread section with a large pitch, in particular a pitch that is greater than the pitch in the anchoring section. The outlets of the individual threads of the double thread create two contact points that reduce the tilting tendency of the outer shell in relation to the head, thus improving the sealing. However, this results in a spread, owing to the larger pitch of the under-head screw thread. Moreover, production of this fastener is complex, as the under-head screw area has to be upset to provide sufficient material for the double thread.

It is the object of the invention to provide a spacing fastener which can be easily produced in a pressing and rolling process and which has improved sealing of the penetration point in the outer shell through which the spacing fastener is inserted.

In a known manner, a spacing fastener for spaced fastening of an outer shell to a substructure has a head and an adjoining shaft. The shaft ends in a tip, in particular a hole-forming tip, and carries an anchoring screw thread for tension-proof anchoring of the fastener in the substructure.

The shaft has an under-head screw thread closest to the head, with a non-threaded shaft section being located between the under-head screw thread and the first anchoring screw thread, with the under-head screw thread terminating close to the head and having an under-head screw thread pitch.

The under-head screw thread forms a contact point A_{U} at the thread runout.

According to the invention, at least one support element is formed on the fastener in addition to the under-head screw thread, which support element is spaced in the circumferential direction from the thread runout of the under-head screw thread. The support element forms a contact point for an outer shell located between the head and the under-head screw thread.

The support element is arranged at a distance from the under-head screw thread in an axial direction, i.e. from the area of the under-head screw thread that overlaps with the support element in the plan view.

Furthermore, the distance from the head to the contact point of the support element is defined as the support element distance D_{S}. According to the invention, the support element distance D_{S} is greater than the distance resulting from the difference between the distance between the outlet of the under-head screw thread and a tolerance value D_{D}. The tolerance distance D_{D} is a maximum of 15%, preferably a maximum of 10%, of the outer diameter of the under-head screw thread.

For example, the maximum distance between the thread runout and the contact point of the support element is around 0.5 mm for standard spacing fasteners.

In particular, the distance between the outlet of the under-head screw thread and the head corresponds to the support element distance D_{S}. This allows the outer shell to be supported orthogonally to the screw axis.

The support element according to the invention provides a further contact point for the outer shell, in addition to the under-head screw thread runout, so that tilting of the outer shell can be kept within narrow limits.

In this way, the outer shell can be lifted over the under-head screw thread as the latter is being screwed in, and then be held clamped between the head, or a sealing washer, and the under-head screw thread.

The support element, which is circumferentially spaced from the under-head screw thread, can thus reduce the tilting tendency of the outer shell in relation to the head and thus in relation to the sealing element when pressure is applied to the outer shell, which keeps the contact pressure of the sealing element evenly distributed. In this way, the support element and the end of the under-head screw thread form a support level that is almost orthogonal to the screw axis.

Furthermore, according to the invention, the support element extends, as viewed from above, in the circumferential direction over an angular extent of between 100° and 150°. The angular distance between the thread runout and the beginning of the support element is preferably more than 50°. This makes it possible to design the support element, particularly with regard to its cross-sectional shape, largely independently of the way the under-head screw thread is designed.

Due to the circumferential spacing of the support element from the under-head screw thread and the circumferential extent of the support element over only a small angular extent, the support element according to the invention can provide a contact point, with only relatively little material having to be displaced for this purpose.

This simplifies production, as the shaft material only has to be upset slightly, preferably by less than 10% of the blank diameter, or even not at all, in the area of the under-head screw thread before rolling, and the core diameter of the under-head screw thread can still correspond to that of the anchoring section. This simplifies the pressing process.

The support element, which is short when measured in the circumferential direction, also allows the outer shell to pass easily between the support element and the under-head screw thread, even if the thread pitch of the under-head screw thread is small.

In a preferred embodiment of the invention, the pitch of the under-head screw thread corresponds to the pitch of the anchoring screw thread.

The same pitch in either case means that the feed rate in the substructure and the feed rate in the outer shell in engagement with the under-head screw thread will also be the same.

In this way, the outer shell and the substructure are not moved away from each other during the screwing process, i.e. spread apart, as would be the case with a larger pitch of the under-head screw thread. This is particularly advantageous when processing sandwich panels in which the outer shell is bonded with insulation.

In another advantageous embodiment of the invention, the support element can have flanks like those of a thread. As a result, the support element can be formed particularly well during the thread rolling process.

In an asymmetrical design of the under-head screw thread, the flank facing the head, which former is referred to as the load flank, may have a flank angle that is smaller than the flank angle of the flank opposite the load flank.

For example, the load flank of the under-head screw thread can have a flank angle of 10° relative to the orthogonal to the screw axis, and the flank opposite the load flank can have an angle of 35°. The small flank angle of the load flank ensures a good contact surface for the outer shell. The flanks of the support element can be designed in the same way as those of the under-head screw thread.

Particularly in the case of spacing fasteners intended for use in a metal substructure, the same pitch of the under-head screw thread and anchoring screw thread means that the under-head screw thread also has a relatively small pitch corresponding to the anchoring screw thread.

Particularly with regard to a small pitch of the under-head screw thread, the thread flanks of the support element can be designed in such a way that they differ in cross-sectional shape.

In particular, the support element can have a cross-sectional shape that is mirror-inverted to the cross-sectional shape of the under-head screw thread.

For example, the load flank of the under-head screw thread can be arranged at a flank angle of 10° relative to the orthogonal to the screw axis, and the flank of the support element arranged opposite the load flank can have the same angle as the load flank of the under-head screw thread, i.e. also an angle of 10°. The other flank can also include the same angle with the orthogonal, for example 35°.

This design allows for the greatest possible axial clearance height between the support element and the under-head screw thread with a low thread pitch.

Especially for spacing fasteners that have a ratio Q1=D_{K}/D_{A} of between 0.6 and 0.8 and a ratio Q2=P_{U}/D_{A} of between 0.25 and 0.35.

This means that even with a small pitch, the under-head screw thread can be easily passed through an outer shell with a common material thickness of more than 0.35 mm, in particular of about 0.5 mm, as the passage of the outer shell between the under-head screw thread and the support element is not obstructed.

The thread point angle between the flanks is preferably greater than 40°. This applies to the support element and the anchoring screw thread as well as to the under-head screw thread. This makes it easier to produce the thread during the thread rolling process.

The support element has a rise in its circumference that is smaller than the pitch of the under-head screw thread. This allows the contact surface for the outer shell to be increased, especially if the pitch of the under-head screw thread is large, without the minimum axial distance between the under-head screw thread and the support element becoming too small, and thus preferably remaining greater than 0.35 mm between the adjacent thread structures.

The anchoring screw thread can be used in such a way that it is either screwed to the substructure or forms a positive fit with the substructure in the pull-out direction.

The support element is preferably designed in such a way that the axial distance to the under-head screw thread decreases in the direction of the head.

Preferably, the flank facing the head is located at the start of the support element below the point, i.e. further away from the head, at which the flank of the under-head screw thread facing the head is at the smallest distance to the head.

This makes it easier to guide the outer shell along the under-head screw thread.

The flank of the support element facing the head continues to approach the head as it progresses, preferably until it is at a distance from the head that is less than or equal to the distance between the flank of the under-head screw thread and the head at the thread runout of the under-head screw thread.

The course of the flank approaching the head is preferably continuous, particularly preferably at a slope angle of less than 45°, especially less than 30°. This prevents the support element from being scraped off after the under-head screw thread has been screwed through the outer shell and the support element is to pass through the outer shell.

The support element has a point or area with a minimum distance from the head.

In top view, this point or this area is preferably opposite the point or area of the under-head screw thread that is at a minimum distance to the head. The angular distance is approximately 180°.

The angular distance is selected to be as large as possible, up to approx. 180°, but can be smaller because of the minimum distance that the lower flank must maintain from the under-head screw thread.

For example, the angular distance can also be 112.5° for a small pitch, with the support element already starting at an angular distance of 60°.

The under-head screw thread tends to terminate abruptly. This improves the load-bearing capacity in conjunction with the support element.

The smallest distance between the under-head screw thread and the support element is greater than half the pitch, but less than the full pitch.

Additional advantages, features and possible applications of the present invention will be apparent from the description which follows, in which reference is made to the embodiments illustrated in the drawings.

In the drawings,

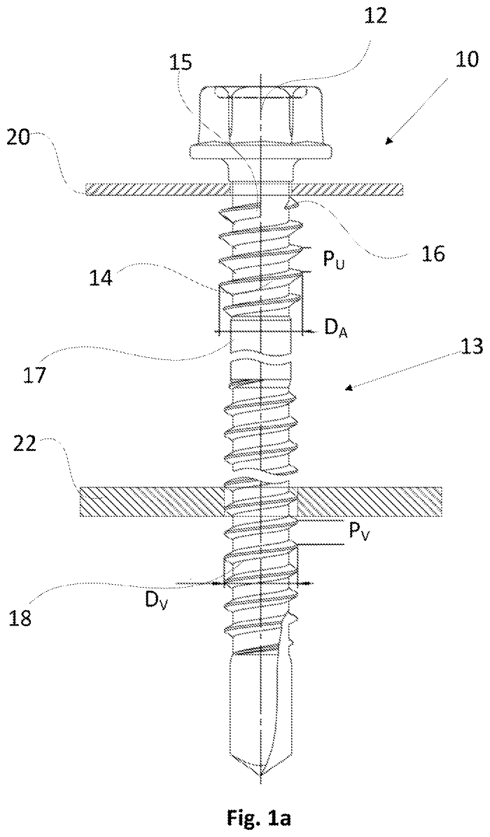

FIG. 1a is a view of a spacing fastener according to the invention;

FIG. 1b is a view of the head area of a spacing fastener according to the invention;

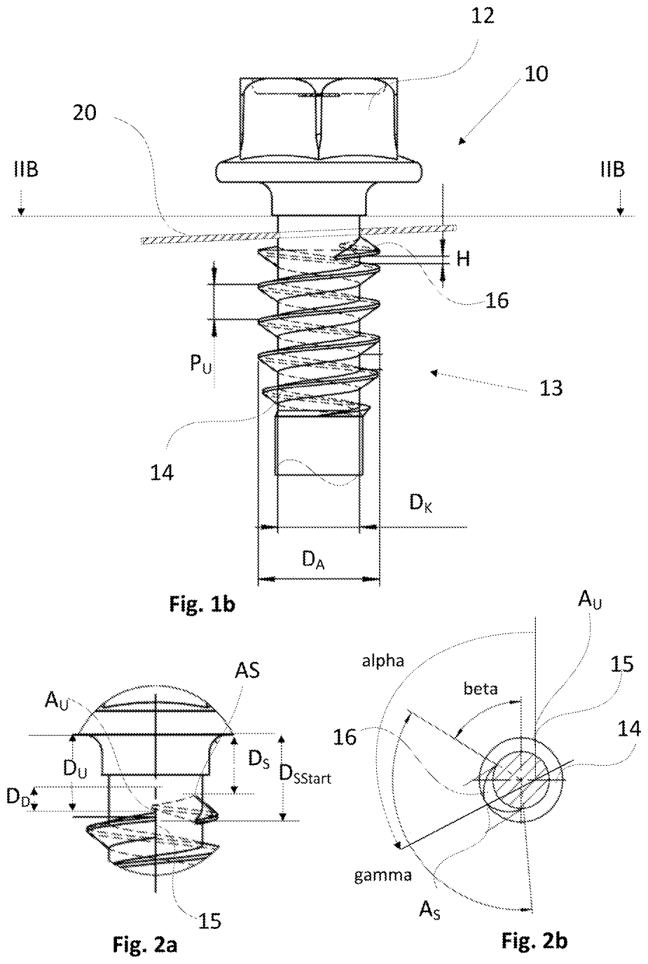

FIG. 2a is a detailed view of the lower head area of the spacing fastener of FIG. 1;

FIG. 2b is a cross-sectional view of FIG. 1;

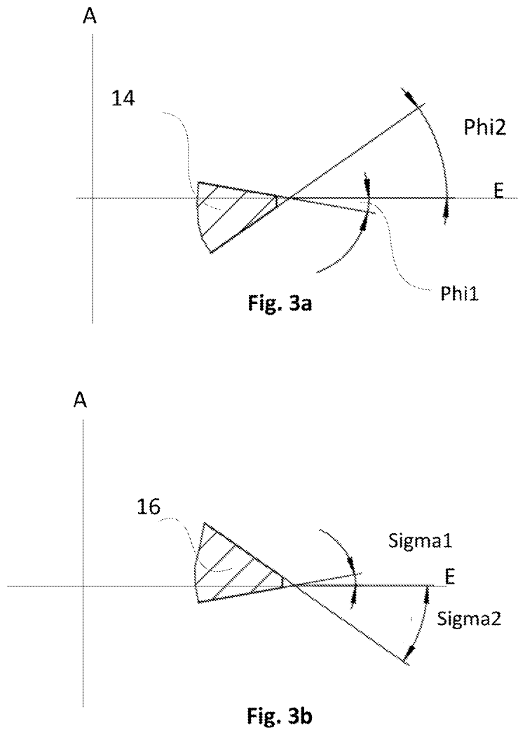

FIG. 3a is a cross-sectional view of the under-head screw thread of FIG. 1;

FIG. 3b is a cross-sectional view of the support element of FIG. 1;

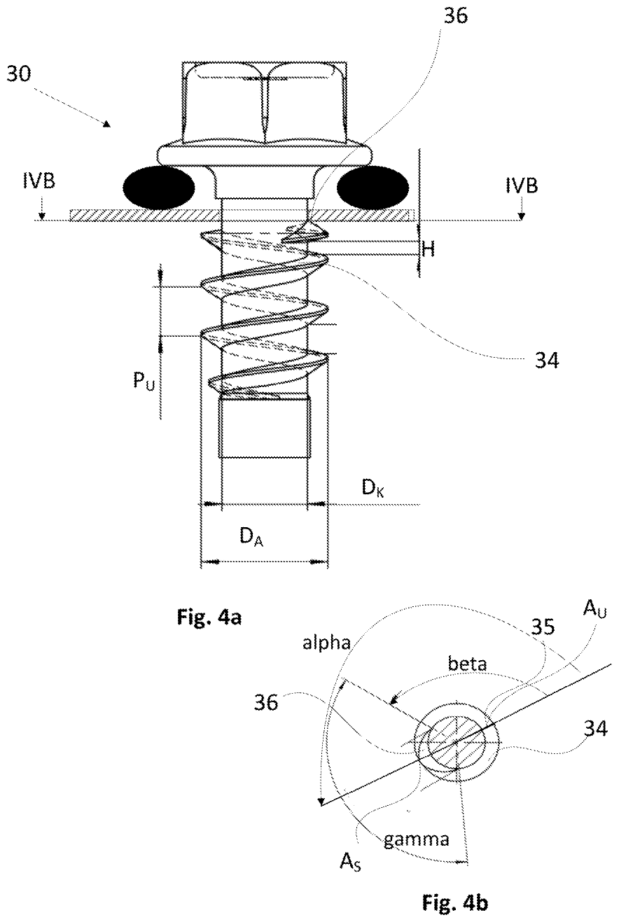

FIG. 4a is a view of the head area of another embodiment of a spacing fastener according to the invention;

FIG. 4b is a cross-sectional view of FIG. 4a; and

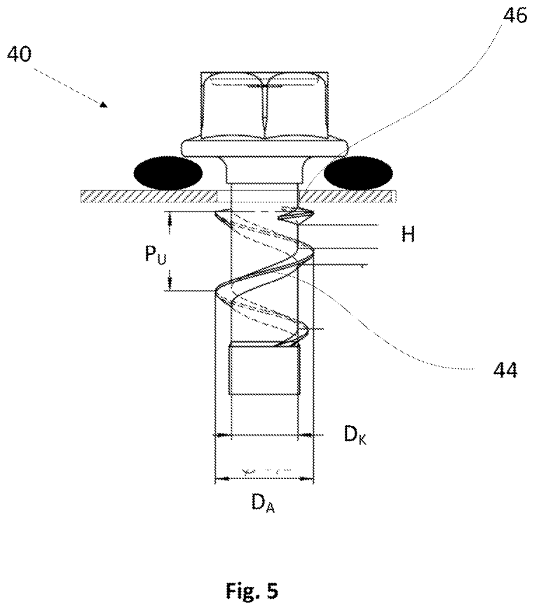

FIG. 5 is a view of the head area of yet another embodiment of a spacing fastener according to the invention.

FIG. 1a is a side view of a spacing fastener 10 according to the invention, with a head 12 and a shaft 13, which latter in this example terminates in a drill tip. The shaft 13 has an under-head screw thread 14 of an outer diameter D_{A}, and an anchoring screw thread of an outer diameter D_{V}. In the present embodiment, the outer diameter D_{A} is slightly larger than D_{V}. The difference can therefore also preferably be less than 10%. More preferably, however, the outer diameters D_{A} and D_{V} can also be the same.

The pitch each of the under-head screw thread P_{U} and of the anchoring screw thread P_{V} are also the same, which has the advantage that the outer shell and substructure are not necessarily moved relative to each other during the screwing process if the substructure and outer shell are made to engage with the spacing fastener 10 at the same time.

Between the anchoring screw thread 18 and the under-head screw thread 14 there is a non-threaded section 17, as is common for spacing fasteners.

In this example, the ratio Q1=D_{K}/D_{A} is 0.67, and Q2=P_{U}/D_{A} is 0.29. As can be seen from Q2, the under-head screw thread has a relatively small pitch P_{U}. As the pitch of the under-head screw thread 14 corresponds to the pitch of the anchoring screw thread 18, this type of spacing fastener 10 is particularly suitable for use in a metal substructure.

The spacing fastener 10 according to the invention has a support element 16 according to the invention in the area of the outlet of the under-head screw thread 14 facing the head 12. This is illustrated in more detail in the detail view of FIG. 1b.

The distance fastener 10 shown there connects a substructure 22 to an outer shell 20. An insulating material can be inserted between the substructure 22 and the outer shell 20.

FIG. 1b shows the head area of a spacing fastener 10 according to the invention. The fastener has a head 12 with drive features, which is connected to a shaft 13. The shaft 13 has an under-head screw thread 14.

In addition to the under-head screw thread, a support element 16 is formed on the shaft 13. The support element 16 is arranged at a distance from the thread runout of the under-head screw thread 14.

The support element 16 also extends over an angular extent of 125°, as can be seen in FIG. 2b, so that the contact points formed by the thread runout of the under-head screw thread and the support element are arranged at a distance from each other.

FIG. 2a is a detailed view of the under-head area of the spacing fastener of FIG. 1, in a position rotated by a quarter turn.

Seen in FIG. 2a is the contact point A_{S} on the support element 16, at which the support element 16 is at its minimum distance D_{S} from the head 12. The under-head screw thread 14 runs out abruptly at its end point 15. At this point, the under-head screw thread 14 is at a distance D_{U} from the head 12.

According to the invention, the load flank of the support element 16 begins below the contact point A_{U} of the under-head screw thread 14 as viewed in the axial direction, which in this case corresponds to the load flank at the thread runout of the under-head screw thread 14.

The beginning of the support element is at a distance D_{Sstart} from the head. The distance Dᵤ is therefore smaller than the distance D_{Sstart}.

This ensures that the support element 16 can grip softly under the outer shell 20 as the spacing fastener 10 is being screwed in, which prevents the support element from being destroyed in the screw-in process.

Furthermore, the tolerance distance D_{D}, which is at most 15%, preferably at most 10%, of the outer diameter D_{A} of the under-head screw thread, is shown. The contact point A_{S} is preferably located at the same distance from the head as the contact point A_{U} of the under-head screw thread, but can also be at a distance from the contact point A_{U} of the under-head screw thread 14 in the direction of the head within the tolerance distance D_{D}. In relation to the distance from the head, the distance of the contact point A_{S} is greater than or equal to the difference between the distance of the contact point A_{U} and the tolerance distance D_{D}.

This keeps the tilting of the outer shell within narrow limits.

FIG. 2b is a cross-sectional view of FIG. 1, which is rotated. The under-head screw thread ends abruptly at its end point 15, which also forms the contact point A_{U} of the under-head screw thread 14.

Starting from the end point 15, the beginning of the support element 14 is spaced counterclockwise at an angular distance beta. In the present case, beta is 60°, because a larger distance is not possible with the under-head screw thread which would still allow the minimum distance H between the support element 16 and the under-head screw thread 14 to be maintained. The support element 16 extends over an angular extent gamma. This is 125° in this case. This length allows the support element 16 to be easily produced by rolling.

The angular distance alpha is the angular distance between the contact point A_{U} of the under-head screw thread 14 and the contact point A_{S} of the support element 16. Although the angular distance alpha here is only around 122°, instead of the desired value of 180°, this can only be achieved for the present thread pitch because the cross-sectional shapes of the support element 16 and the under-head screw thread 14 are matched to each other. This is illustrated in more detail in FIGS. 3a and 3b.

The under-head screw thread has a cross-sectional shape as shown in FIG. 3a, and the support element has a cross-sectional shape as shown in FIG. 3b.

The two cross-sectional shapes have identical flank angles, but are mirrored at the orthogonal.

FIG. 3a shows part of the cross-section of the under-head screw thread 14, which forms a load flank angle phi_1 with the plane E, which is orthogonal to the screw center axis A. The flank opposite the load flank includes a flank angle of phi_2 with the plane E. Preferably, phi_1 is selected to be smaller than phi_2 for the under-head screw thread. In the case of the spacing fastener according to the invention, phi_1 is 10° and phi_2 is 35°.

FIG. 3b shows part of the cross-sectional shape of the support element 16, which accordingly has a load flank angle of sigma_1 and a flank angle of sigma_2 opposite the load flank.

In this way, the opposing flanks on the support element 16 and on the under-head screw thread 14 are formed with a small flank angle phi_1 and sigma_2, so that there is an improved clearance height H at the core diameter between the under-head screw thread and the support element 16.

The position of the threaded tip of the under-head screw thread runout and of the radially outermost point of the support element 16 is preferably in approximately the same plane orthogonal to the screw center axis.

In this design with the same thread pitch and correspondingly thin sheet thickness, a double thread would result in the distance between the two threads being too small for the support element to pass through the outer shell without a thread being formed in the outer shell.

However, the support element according to the invention provides a support with the necessary clearance height without the support element and the under-head screw thread coming too close to each other in their course and thus hindering the passage through the outer shell.

The distance between the point of the load flank of the under-head screw thread that is closest to the head and that of the support element can be kept small due to the choice of the cross-sectional shape of the support element, so that the tilting tendency is significantly reduced even under high wind pressure.

The circumferential distance between the under-head screw thread and the support element makes it easier to change the geometry and offset between the under-head screw thread and the support element than would be the case with a continuous thread.

FIG. 4a is a view of another embodiment of a spacing fastener 30 according to the invention, of a design similar to that of FIG. 1, in which the support element 36 and the under-head screw thread 34 are also asymmetrical and mirrored. In the embodiment of FIG. 3, the ratio Q2 is approximately 0.4, with Q1 corresponding to that of FIG. 1. Such a ratio is particularly suitable for screwing into a wooden substructure.

FIG. 4b is the sectional view IVB-IVB, in which it is clearly seen that the support element 16 extends over the same angular extent gamma, but the position differs from the embodiment of FIG. 1. Because the pitch of the under-head screw thread P_{U} is higher in the case of the spacing fastener 30 than in the embodiment of FIG. 1, the support element 36 can be spaced further away from the contact point A_{U} of the under-head screw thread and still provide a sufficient clearance height H.

The angular distance between the contact point A_{U} of the under-head screw thread and the contact point of the support thread A_{S} is 180° in this case. Because the under-head screw thread 34 ends abruptly at the contact point, the angular distance beta between the end of the under-head screw thread and the beginning of the support element is 117.5°.

The view of FIG. 5 is another embodiment of a spacing fastener 40 according to the invention, which fastener has a ratio of Q2 of approximately 0.65. Such a design of the under-head screw thread 44 corresponds to an anchoring screw thread, which is preferably suitable for fastening in a concrete component.

In this embodiment example, the cross-sectional shape is the same for the support element 46 and for the under-head screw thread 44, in particular as seen in FIG. 3a. Owing to the rather large pitch with regard to the usual sheet thicknesses of outer shells, the small flank angle of the load flank can also be maintained in the support element 46, while still ensuring a sufficient clearance height H between the under-head screw thread 44 and the support element 46.

Thanks to the nevertheless short and spaced support element, a spacing fastener 40 with an improved sealing effect can easily be produced with the same core diameter and the same tube diameter throughout. Alternatively, if the under-head screw thread 44 is to have a larger outer diameter than the anchoring screw thread, only a slight upsetting of the under-head area is necessary before rolling.

In the embodiment illustrated in FIG. 5, the contact point A_{S} of the support screw thread and the contact point A_{U} of the under-head screw thread are spaced at the same distance from the head.

The angular distances and the angular extent correspond to those of FIG. 4b.

1-15. (canceled)

16. A spacing fastener (10, 30, 40) for fastening an outer shell (20) to a substructure, comprising
a head (12), and
a shaft adjoining the head (12) and ending in a tip, wherein the shaft bears an anchoring screw thread for tension-resistant anchoring in the substructure, and comprises an under-head screw thread (14) closest to the head; there is a non-threaded shaft portion (17) between the under-head screw thread (14, 34, 44) and the anchoring screw thread (18); the under-head screw thread (14, 34, 44) ends close to the head (12) and comprises an under-head screw thread pitch (P_{U}),
wherein, in addition to the under-head screw thread (14, 34, 44), a support element (16) is formed at a distance, in the circumferential direction, from the screw thread end of the under-head screw thread (14, 34, 44), which under-head screw thread (14, 34, 44) forms a contact point (A_{U}),
the support element is spaced apart from the under-head screw thread in the region in which the support element overlaps with the under-head screw thread in a top view, wherein the support element (16) forms a contact point (A_{S}) for an outer shell (20) located between the head (12) and the under-head screw thread (14, 34, 44),
the distance of the contact point (A_{S}) of the support element (16, 36, 46) from the head is greater than or equal to the difference between the distance of the contact point (A_{U}) of the under-head screw thread (14, 34, 44) from the head and a tolerance distance DD, which is at most 15% of the outside diameter (D_{A}) of the under-head screw thread (14, 34, 44), and
the length of the support element extends over an angular extent (gamma) which is less than 150°.

17. The spacing fastener according to claim 16, wherein the beginning of the support element (16, 36, 46) is located at a greater distance from the head than the contact point (A_{U}) of the under-head screw thread (14, 34, 44).

18. The spacing fastener according to claim 16, wherein the under-head screw thread (14, 34, 44) is a single-start thread.

19. The spacing fastener according to claim 16, wherein the pitch (P_{U}) of the under-head screw thread (14, 34, 44) is greater than the rise in the support element (16, 36, 46).

20. The spacing fastener according to claim 16, wherein the under-head screw thread (14, 34, 44) ends abruptly.

21. The spacing fastener according to claim 16, wherein the angular distance (alpha) between the contact point (A_{S}) of the support element (16, 36, 46) and the contact point (A_{U}) of the under-head screw thread (14, 34, 44) is between 110° and 190°.

22. The spacing fastener according to claim 16, wherein the angular distance (beta) between the end of the under-head screw thread (14, 34, 44) and the beginning of the support element (16, 36, 46) is between 50° and 150°.

23. The spacing fastener according to claim 16, wherein the minimum distance of the support element (16, 36, 46) from the under-head screw thread in the region in which the support element overlaps with the under-head screw thread in top view defines a clearance height (H) which is greater than 0.4 mm.

24. The spacing fastener according to claim 16, wherein the support element (34) has two flanks.

25. The spacing fastener according to claim 24, wherein the tip angle of the support element (16, 36, 46) corresponds to that of the under-head screw thread (14).

26. The spacing fastener according to claim 24, wherein the flank of the support element (16, 36) facing the screw tip forms an angle (sigma_2) with the plane (E), which is orthogonal to the screw axis (A), which angle is smaller than the angle (phi_2) of the flank of the under-head screw thread facing the screw tip.

27. The spacing fastener according to claim 16, wherein the flank of the under-head screw thread (16, 36) facing the screw tip forms an angle (phi_2) with the plane (E), which is orthogonal to the screw axis (A), which angle is greater than the angle (phi_1) of the flank of the under-head screw thread facing the screw tip.

28. The spacing fastener according to claim 24, wherein the support element (16, 36) has a cross-section which corresponds to the cross-section of the under-head screw thread (14, 34) mirrored at the plane (E) which is orthogonal to the screw axis.

29. The spacing fastener according to claim 16, wherein the anchoring screw thread has the same pitch as the under-head screw thread (14, 34, 44).

30. An assembly, comprising
a substructure,
the spacing fastener as described in claim 16, wherein the spacing fastener is anchored in the substructure,
wherein an outer shell is held in place between the head and the under-head screw thread, with the thickness of the outer shell being less than the minimum axial distance between the support element and the under-head screw thread.
